(19) United States
(12) Patent Application Publication
(10) Pub. No.: US 2024/0254055 A1
(43) Pub. Date: Aug. 1, 2024

(54) PREPARATION METHOD OF OXIDE HIGH-ENTROPY CERAMIC FIBER

(71) Applicant: SHAN DONG UNIVERSITY, Jinan (CN)

(72) Inventors: Luyi ZHU, Jinan (CN); Zhezhe DENG, Jinan (CN); Yongshuai XIE, Jinan (CN); Xinqiang WANG, Jinan (CN); Guanghui ZHANG, Jinan (CN); Dong XU, Jinan (CN)

(73) Assignee: SHAN DONG UNIVERSITY, Jinan (CN)

(21) Appl. No.: 18/564,080

(22) PCT Filed: Feb. 7, 2022
(86) PCT No.: PCT/CN2022/075328

§ 371 Date: Nov. 25, 2023

(30) Foreign Application Priority Data
May 26, 2021 (CN) 202110578534.2

(51) Int. Cl. C04B 35/622; C04B 35/64

(52) U.S. Cl. CPC C04B 35/6225; C04B 35/62259; C04B 35/64; C04B 2235/3225; C04B 2235/3229; C04B 2235/3232; C04B 2235/3244; C04B 2235/48; C04B 2235/6562; C04B 2235/6567

(57) ABSTRACT

The present invention relates to a method of preparing an oxide high entropy ceramic fiber; the oxide high entropy ceramic fiber of the present invention comprises five elements among Zr, Hf, Ti, Ce, Y, La, Gd, Er, Sm; the salt or precursor corresponding to the selected element is used as a metal source, anhydrous ethanol or anhydrous methanol is used as a solvent, polyvinylpyrrolidone or polyethylene oxide is used as a spinning aid to configure a spinning solution, the precursor fibers are prepared by electrostatic spinning, and the precursor fibers are heat-treated in air to obtain the oxide high-entropy ceramic fibers; the oxide high entropy ceramic fiber prepared by the present invention has a uniform diameter and good flexibility.

### TECHNICAL FIELD

The present invention describes a technique for fabricating high-entropy oxide ceramic fibers and falls under the realm of high-entropy ceramics.

### BACKGROUND OF THE INVENTION

High-entropy ceramics are single-phase solid solutions that are composed of 5 to 13 elements with equal or nearly equal atomic ratios. They are multi-component in nature and employ a range of entropies. High-entropy ceramics exhibit exceptional properties attributable to their thermodynamic high entropy effect, structural distortion effect, kinetic hysteresis diffusion effect, and performance of the “cocktail” effect. As a result, they find varied applications in areas such as thermal protection, catalysis, energy storage, thermal compression, and thermoelectricity.

However, currently, research on high entropy ceramics primarily focuses on ceramic powder and block, with less research conducted on high entropy ceramic fiber. High entropy ceramic fiber boasts excellent flexibility, a large aspect ratio, and specific surface area, which can broaden the application field of high entropy ceramics and enhance their performance. Chinese patent documents CN111592361A and CN111592358A reveal the processes for creating high-entropy ceramic fibers of nitride and carbide, correspondingly. CN110204328A discloses a method for preparing high-entropy oxide ceramic fibers using raw materials such as MgO, ZnO, NiO, CuO, CaO, CoO, ZrO2, CeO2, Al2O3, Gd2O3, La2O3, Er2O3, Y2O3, Fe2O3, Co3O4, and CaCO3. The raw materials are mixed to create a raw billet which is then pre-treated at 500° C. After treatment in a scintillation furnace, the sample is rapidly immersed in cold water for quenching and cooling, which is a complex procedure.

Therefore, it is significant to develop a procedure for producing oxide high-entropy ceramic fibers using a simple process that avoids complex heat treatment and atmosphere protection.

### SUMMARY OF THE INVENTION

In response to the shortcomings of existing research, the presented study introduces a technique for creating high-entropy ceramic fibers made of oxides. This novel approach utilizes electrostatic spinning with elemental precursors that are contained within the system.

The technical program of the invention is as follows:

A method for preparing oxide high-entropy ceramic fibers includes the following steps:

An organic polymer precursor containing at least five of the following elements—Zr, Hf, Ti, Ce, Y, La, Gd, Er, Sm—or its corresponding nitrate is utilized as the metal source, while either anhydrous methanol, anhydrous ethanol, or a combination of both serves as the spinning solvent. To configure the spinning solution, polyvinylpyrrolidone (PVP), polyethylene oxide (PEO), or a mixture of the two is used as the spinning aid. Biased language and subjective evaluations are avoided while following a logical structure with causal connections. They are mixed in a mass ratio of (10-30):(20-40):(0.06-0.15).

The electrostatic spinning solution produced oxide high-entropy ceramic precursor fibers at a spinning voltage range of 4-10 kV. These precursor fibers were subsequently heat- treated in air to result in oxide high-entropy ceramic fibers.

Preferably, the total content of each metal element in the high-entropy oxide ceramic fiber is 5% to 35% of the total mass of the ceramic fiber, according to the present invention.

Preferably, the high entropy oxide ceramic fiber in this study includes five elements—Zr, Hf, Ti, Ce, and Y—in equal amounts. Additionally, La, Gd, Er, and Sm are present in equal amounts as well.

Preferably, according to the present invention, the oxide high entropy ceramic fibers are prepared with better quality by using four or four or more of the organic precursors of Zr, Hf, Ti, Ce, Y, La, Gd, Er, Sm as the metal source.

Preferably, according to the present invention, the mass ratio of the metal source, the spinning solvent, and the spinning aid is (15-20):(25-40):(0.075-0.1).

Preferably, according to the present invention, the spinning fluid advance rate is 1.5-3.5 ml/h and the spinning environment humidity is 10%-40%.

Preferably, according to the present invention, the heat treatment temperature is 700° C.-1100° C.

Preferably, according to the present invention, the heat treatment process is as follows: the temperature increase rate is 0.5° C./min-1° C./min before 400° C., the temperature increase rate is 1° C./min-3° C./min after 400° C., the holding time is 1-2h, and the cooling with the furnace.

According to the present invention, said Zr, Ti, Ce, Y, La, Gd, Er, Sm organic polymer precursor can be prepared and obtained by reference to the prior art, which can be found in Chinese patent documents CN1459418A, CN108315838A, CN104961763A and CN111187424A.

Preferably, according to the present invention, the hafnium elemental organic precursor, is synthesized according to the following steps:
(1) Hafnium oxychloride octahydrate, acetylacetone, triethylamine as the main raw materials, respectively, diluted in an alcoholic solvent, using magnetic stirring to mix the solution uniformly, stirring uniformly after drying under reduced pressure at 30° C.˜40° C., to obtain polyacetylacetonate hafnium containing triethylamine hydrochloride;
(2) Soak the polyacetylacetonate hafnium containing triethylamine hydrochloride into acetone, and filter it after standing for 24 to 72 hours to remove the triethylamine hydrochloride, and the resulting filtrate is dried under reduced pressure at 20° C. to 30° C. to obtain polyacetylacetonate hafnium powder.

Preferably, according to the present invention, the molar ratio of hafnium oxychloride octahydrate: acetylacetone: triethylamine in step (1) is: 1:0.5 to 2:1.5 to 3, and the amount of alcohol solvent added per mole of hafnium oxychloride octahydrate is 900 to 130 0g.

Preferably, according to the present invention, the alcohol solvent in step (1) may be anhydrous ethanol or anhydrous methanol.

Preferably, according to the present invention, the amount of polyacetylacetonate hafnium added to each gram of polyacetylacetonate hafnium in step (2) is 10 ml to 30 ml of acetone, the resting time is 24 h to 72 h, and the drying temperature is 20° C. to 30° C.

The oxide high entropy ceramic fiber produced by this method possesses excellent flexibility and finds application in high-temperature insulation, thermal and environmental protection, and catalysis, among others.

Technical features and excellent effects of the present invention:

The present invention has successfully produced oxide high-entropy ceramic fibers comprising five or more elements, including Zr, Hf, Ti, Ce, Y, La, Gd, Er, and Sm. The ratios of the elements in the fibers are approximately equimolar and evenly distributed, making this the first preparation of its kind.

2. The present invention utilizes four or more organic precursors, including those of Zr, Hf, Ti, Ce, Y, La, Gd, Er, Sm as the metal source, resulting in high-entropy ceramic fibers in a single crystal phase. The obtained results demonstrate the effectiveness of this approach in producing high-quality ceramic fibers with improved properties.

3. Additionally, this invention incorporates polyacetylacetonate hafnium as the hafnium source, enhancing the spinnability and quality of the high-entropy fibers.

4. The high-entropy oxide ceramic fiber prepared by this invention has a uniform diameter and enhanced flexibility.

5. Additionally, the advanced preparation technique does not demand complex heat treatment or atmosphere protection, allowing for a simplified process.

### BRIEF DESCRIPTION OF DRAWINGS

FIG. 1 is a physical diagram of an oxide high entropy ceramic fiber obtained from Example 2.

FIG. 2 is a physical diagram of the oxide high entropy ceramic fiber obtained from Example 3.

FIG. 3 is a physical drawing of the oxide high entropy ceramic fiber obtained from Comparative example 2.

FIG. 4 is a low magnification SEM image of the oxide high entropy ceramic fiber obtained from Example 2.

FIG. 5 is a high magnification SEM image of the oxide high entropy ceramic fiber obtained from Comparative example 2.

FIG. 6 is an XRD image of an oxide high entropy ceramic fiber obtained from Example 3.

FIG. 7 is an XRD image of the oxide high entropy ceramic fiber obtained from Example7.

FIG. 8 is an XRD image of the oxide powder obtained from Comparative example 3.

FIG. 9 is an XRD plot of oxide high entropy ceramic fiber obtained from Comparative example 4.

### DETAILED DESCRIPTION OF THE INVENTION

The present invention is further described below in conjunction with, but not limited to, specific embodiments and the accompanying drawings.

The Zr, Ti, Ce, Y, La, Gd, Er, Sm organic polymer precursors in the embodiments were prepared with reference to Chinese patent documents CN1459418A, CN108315838A, CN104961763A and CN111187424A.

### Example 1

A method of preparing a hafnium polymer precursor, comprising the steps as follows:
(1) dissolve 60 g of hafnium oxychloride octahydrate in 150 g of anhydrous methanol, add 15 g of acetylacetone after complete dissolution, stir for 1 hour, then add 27 g of triethylamine drop by drop, and continue stirring for 1 hour after completion of the dropwise addition, to obtain a yellow clarified solution;
(2) Pour the yellow solution obtained in (1) into a round-bottomed flask, distill under reduced pressure at 38° C. to obtain a dry powder mixed with triethylamine hydrochloride and polyacetylacetonate hafnium, after which 200 ml of acetone was added to the round-bottomed flask, the round-bottomed flask was sealed, and left to stand for 48 hours;
(3) filtering the insoluble triethylamine hydrochloride in the round-bottomed flask described in (2) to obtain an acetone solution of polyacetylacetonate hafnium, which is poured into a round-bottomed flask for decompression distillation to dryness, and the temperature of the decompression distillation is 32° C. to obtain a precursor powder of polyacetylacetonate hafnium.

### Example 2

A method of preparing an oxide high-entropy ceramic fiber comprising the steps as follows:
(1) Take 15 g of equal molar ratio Zr, Hf, Ti, Y, Gd five elements precursor dissolved in 25 g of anhydrous ethanol, add 0.075 g of polyethylene oxide (PEO) for magnetic stirring, and continue stirring for 1 hour after complete dissolution, and leave the well-stirred solution for 1 hour to obtain the desired high entropy ceramic precursor spinning solution.
(2) The prepared spinning solution was subjected to electrostatic spinning with a spinning voltage of 9 kV, a syringe pump propulsion speed of 1.5 ml/h, an ambient humidity of 30% and a spinning temperature of room temperature.
(3) The precursor fibers obtained in (2) were heat-treated at 800° C., in which the temperature increase rate was 0.5° C./min before 400° C., and the temperature increase rate was 1° C./min from 400° C. to 800° C., and the holding time was 2 h, and then cooled with the furnace, which can be the oxide high-entropy ceramic fibers.

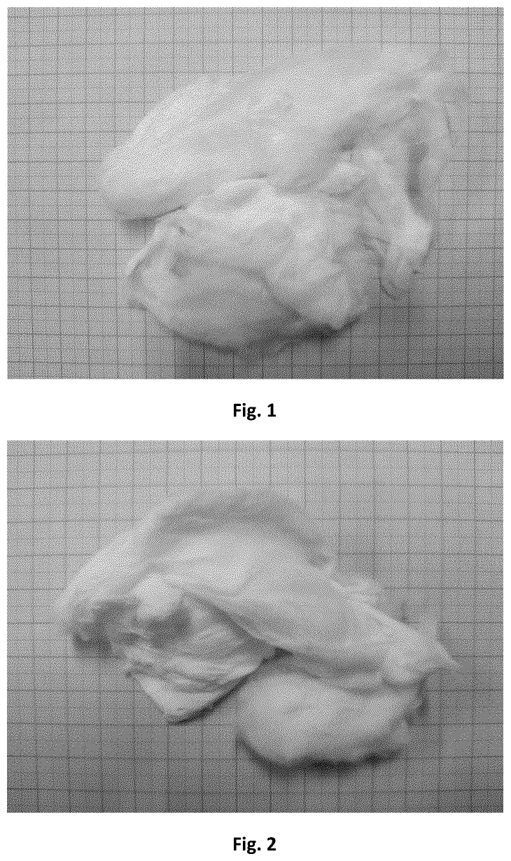

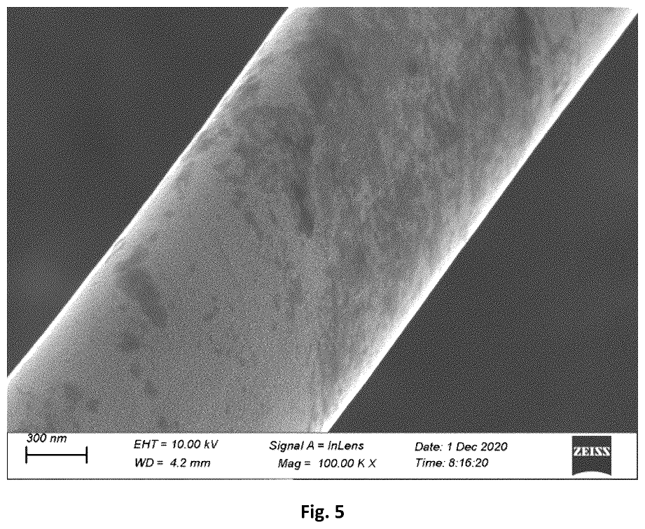

The macroscopic diagram of the prepared oxide high entropy ceramic fiber is shown in FIG. 1, the low magnification SEM diagram is shown in FIG. 4, and the high magnification SEM is shown in FIG. 5.

### Example 3

A method of preparing an oxide high-entropy ceramic fiber comprising the steps as follows:
(1) Take 15 g of equal molar ratio Zr, Hf, Ti, Y, Gd five elements precursor dissolved in 25 g of anhydrous ethanol, add 0.075 g of polyethylene oxide (PEO) for magnetic stirring, and continue stirring for 1 hour after complete dissolution, and leave the well-stirred solution for 1 hour to obtain the desired high entropy ceramic precursor spinning solution.
(2) The prepared spinning solution was subjected to electrostatic spinning with a spinning voltage of 9 kV, a syringe pump propulsion speed of 1.5 ml/h, an ambient humidity of 30% and a spinning temperature of room temperature.
(3) The precursor fibers obtained in (2) were heat-treated at 1000° C., in which the temperature increase rate was 0.5° C./min before 400° C., and the temperature increase rate was 1° C./min from 400° C. to 1000° C., and the holding time was 2 h, and then cooled with the furnace, which can be oxide high-entropy ceramic fibers.

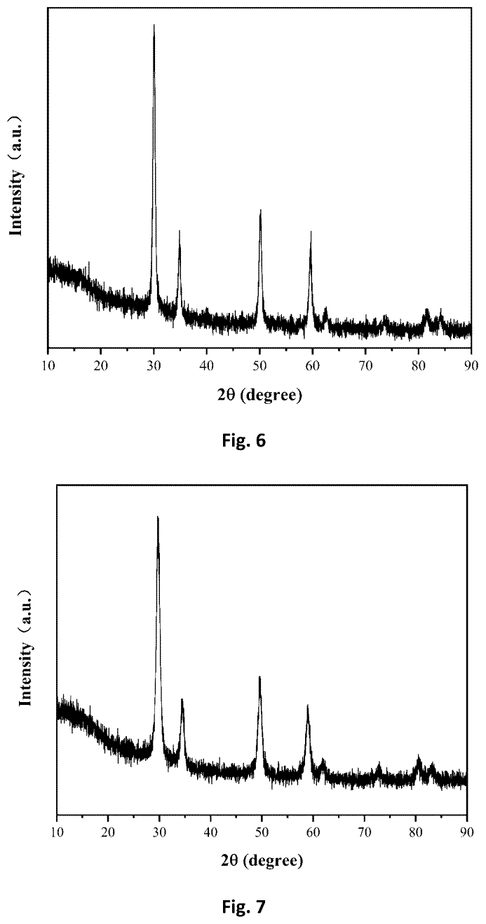

The macroscopic diagram of the prepared oxide high entropy ceramic fiber is shown in FIG. 2, and the XRD diagram is shown in FIG. 6.

### Example 4

A method of preparing an oxide high-entropy ceramic fiber comprising the steps as follows:
(1) Take 15 g of equal molar ratio Zr, Hf, Ti, Y, Ce five elements precursor dissolved in 25 g of anhydrous ethanol, add 0.075 g of polyethylene oxide (PEO) for magnetic stirring, and continue stirring for 1 hour after complete dissolution, and leave the well-stirred solution for 1 hour to obtain the desired high entropy ceramic precursor spinning solution.
(2) The prepared spinning solution was subjected to electrostatic spinning with a spinning voltage of 9 kV, a syringe pump propulsion speed of 1.5 ml/h, an ambient humidity of 30% and a spinning temperature of room temperature.
(3) The precursor fibers obtained in (2) were heat-treated at 1000° C., in which the temperature increase rate was 0.5° C./min before 400° C., and the temperature increase rate was 1° C./min from 400° C. to 1000° C., and the holding time was 2 h, and then cooled down with the furnace, which can be the oxide high-entropy ceramic fibers.

### Example 5

A method for the preparation of oxide high entropy ceramic fiber comprising the steps as follows:
(1) Take 15 g of equal molar ratio Zr, Hf, Ti, Y, Er five elements precursor dissolved in 25 g of anhydrous ethanol, add 0.075 g of polyethylene oxide (PEO) for magnetic stirring, and continue stirring for 1 hour after complete dissolution, and leave the well-stirred solution for 1 hour to obtain the desired high entropy ceramic precursor spinning solution.
(2) The prepared spinning solution was subjected to electrostatic spinning with a spinning voltage of 4.5 kV, a syringe pump advance rate of 1.5 ml/h, an ambient humidity of 30% and a spinning temperature of room temperature.
(3) The precursor fibers obtained in (2) were heat-treated at 1000° C., in which the temperature increase rate was 0.5° C./min before 400° C., the temperature increase rate was 1° C./min from 400° C. to 1000° C., and the holding time was 2 h. After that, they were cooled with the furnace, and then the oxidized high-entropy ceramic fibers were available.

### Example 6

A method of preparing an oxide high-entropy ceramic fiber comprising the steps as follows:
(1) Take 15 g of equal molar ratio Zr, Hf, Ti, Gd, Sm five elements precursor dissolved in 25 g of anhydrous ethanol, add 0.075 g of polyethylene oxide (PEO) for magnetic stirring, and continue stirring for 1 hour after complete dissolution, and leave the well-stirred solution for 1 hour to obtain the desired high entropy ceramic precursor spinning solution.
(2) The prepared spinning solution was subjected to electrostatic spinning with a spinning voltage of 5 kV, a syringe pump propulsion speed of 1.5 ml/h, an ambient humidity of 30% and a spinning temperature of room temperature.
(3) The precursor fibers obtained in (2) were heat-treated at 1000° C., in which the temperature increase rate was 0.5° C./min before 400° C., and the temperature increase rate was 1° C./min from 400° C. to 1000° C. The holding time was 2 h, and then cooled with the furnace, and then the oxidized high-entropy ceramic fibers were available.

### Example 7

A method for the preparation of oxide high entropy ceramic fiber comprising the steps as follows:
(1) Take 15 g of equal molar ratio Zr, Hf, Ti, Y, Sm five elements precursor dissolved in 25 g of anhydrous ethanol, add 0.075 g of polyethylene oxide (PEO) for magnetic stirring, and continue stirring for 1 hour after complete dissolution, and leave the well-stirred solution for 1 hour to obtain the desired high entropy ceramic precursor spinning solution.
(2) The prepared spinning solution was subjected to electrostatic spinning with a spinning voltage of 5 kV, a syringe pump propulsion speed of 1.5 ml/h, an ambient humidity of 30% and a spinning temperature of room temperature.
(3) The precursor fibers obtained in (2) were heat-treated at 1000° C., in which the temperature increase rate was 0.5° C./min before 400° C., the temperature increase rate was 1° C./min from 400° C. to 1000° C., and the holding time was 2 h, and then cooled with the furnace, i.e., available oxide high-entropy ceramic fibers. The XRD of the prepared fiber is shown in FIG. 7.

### Example 8

A method of preparing an oxide high-entropy ceramic fiber comprising the steps as follows:
(1) Take 15 g of equal molar ratio Zr, Hf, Ti, Ce, Sm five elements precursor dissolved in 25 g of anhydrous ethanol, add 0.075 g of polyethylene oxide (PEO) for magnetic stirring, and continue stirring for 1 hour after complete dissolution, and leave the well-stirred solution for 1 hour to obtain the desired high entropy ceramic precursor spinning solution.
(2) The prepared spinning solution was subjected to electrostatic spinning with a spinning voltage of 5 kV, a syringe pump propulsion speed of 1.5 ml/h, an ambient humidity of 30% and a spinning temperature of room temperature.
(3) The precursor fibers obtained in (2) were heat-treated at 1000° C., in which the temperature increase rate was 0.5° C./min before 400° C., and the temperature increase rate was 1° C./min from 400° C. to 1000° C., and the holding time was 2 h, and then cooled down with the furnace, which can be the oxide high-entropy ceramic fibers.

### Example9

A method for the preparation of oxide high entropy ceramic fiber comprising the steps as follows:
(1) Take 15 g of equal molar ratio Zr, Hf, Ti, La, Gd five elements precursor dissolved in 25 g of anhydrous ethanol, add 0.075 g of polyethylene oxide (PEO) for magnetic stirring, and continue stirring for 1 hour after complete dissolution, and leave the well-stirred solution for 1 hour to obtain the desired high entropy ceramic precursor spinning solution.
(2) The prepared spinning solution was subjected to electrostatic spinning with a spinning voltage of 6 kV, a syringe pump propulsion speed of 1.5 ml/h, an ambient humidity of 30% and a spinning temperature of room temperature.
(3) The precursor fibers obtained in (2) were heat-treated at 1000° C., in which the temperature increase rate was 0.5° C./min before 400° C., and the temperature increase rate was 1° C./min from 400° C. to 1000° C., and the holding time was 2 h, and then cooled down with the furnace, which can be the oxide high-entropy ceramic fibers.

### Comparative Example 1

As described in Example 1, the difference was that the addition of 27 g of triethylamine was changed to 40 g in step (1), and it was found that a large amount of white precipitate was formed during dropwise addition, and after filtration and following the steps after Example 1, the yield of the polyacetylacetonate hafnium obtained decreased.

### Comparative Example 2

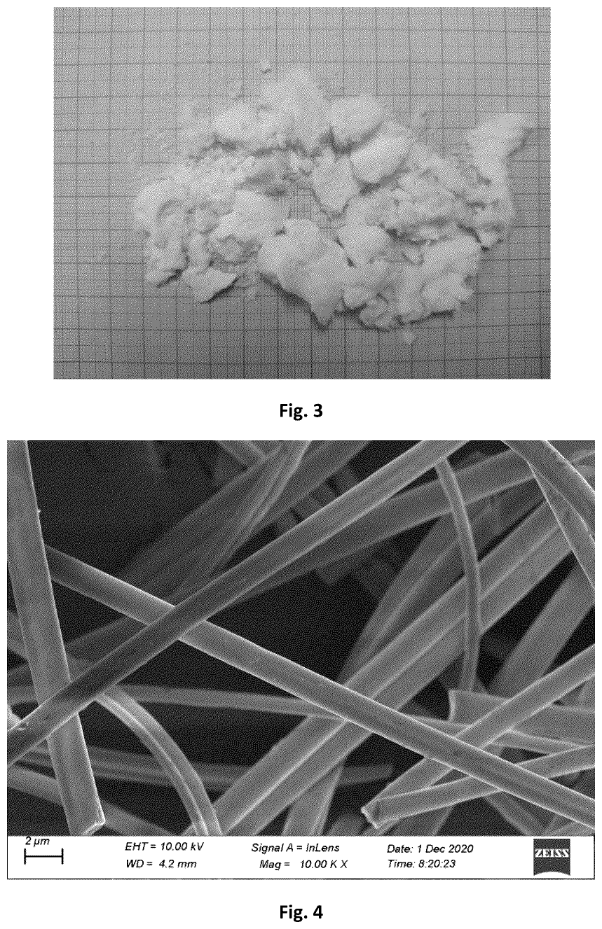

In Example 2, the precursor of Y, Gd two elements were replaced with their corresponding nitrates, and the macroscopic morphology of the prepared fiber is shown in FIG. 3, which shows that if the nitrate content in the spinning solution is high, it will directly affect the quality of the fiber, resulting in brittle fibers, and the flexibility decreases sharply.

### Comparative Example 3

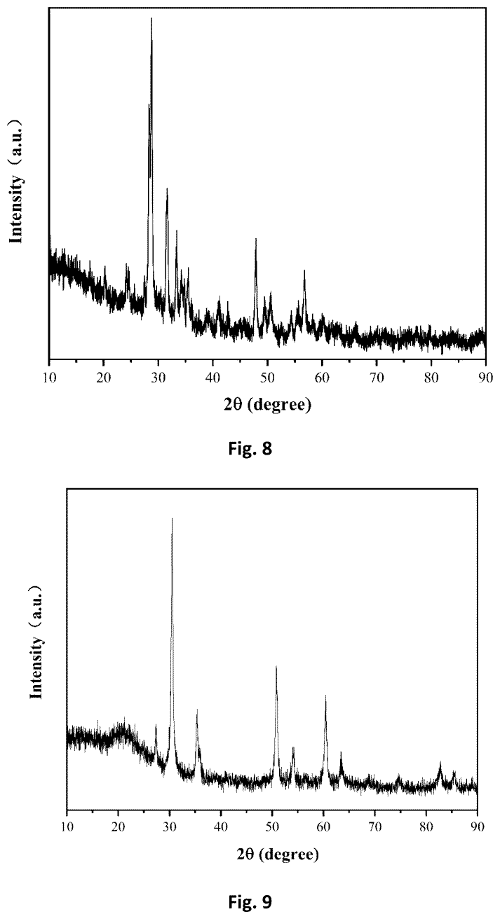

The elements contained in Examples 4, 5, 6, and 7 were used as raw materials with their corresponding precursors or nitrates, and the powders were mechanically mixed, and after mixing well, the powders were subjected to the same heat treatment as in Examples 4, 5, 6, and 7, wherein the final powder obtained was not a single phase. The XRD of one of the powders prepared with the same elements as in Example 7 after heat treatment is shown in FIG. 8.

Comparative Example 4

Hafnium oxychloride in Example 1 was replaced with salts of hafnium oxychloride, zirconium oxychloride, titanium tetrachloride, and yttrium trichloride, and mixed in equimolar ratios to form a precursor mixture of the four elemental elements Zr, Hf, Ti, Y, and Gd. All other conditions remained unchanged, and the resulting fibers were stronger as well as more flexible, but their phases appeared to have a second phase that was not a single crystalline phase. The XRD of this proportional ratio 4 is shown in FIG. 9.

What is claimed is:

1. A method for preparing an oxide high entropy ceramic fiber comprising the steps of:
configuring a spinning solution with an organic polymer precursor of at least five elements of Zr, Hf, Ti, Ce, Y, La, Gd, Er, Sm and/or its corresponding nitrate as a metal source, anhydrous methanol or anhydrous ethanol or a mixture thereof as a spinning solvent, and polyvinylpyrrolidone (PVP), polyethylene oxide (PEO), or a mixture of PVP and PEO as a spinning auxiliary; the mass ratio of the metal source, the spinning solvent The mass ratio of the metal source, spinning solvent, and spinning aid was (10-30):(20-40):(0.06-0.15);
the spinning solution was electrostatically spun at a spinning voltage of 4-10 kV to obtain oxide high-entropy ceramic precursor fibers, and the precursor fibers were heat-treated in air to obtain oxide high-entropy ceramic fibers.

2. The method of preparing the oxide high entropy ceramic fibers according to claim 1, characterized in that the total content of each metal element in the oxide high entropy ceramic fibers accounts for 5% to 35% of the total mass of the oxide high entropy ceramic fibers.

3. The method for preparing the oxide high-entropy ceramic fiber according to claim 1, characterized in that said high-entropy oxide ceramic fiber comprises five elements among Zr, Hf, Ti, Ce, Y, La, Gd, Er, Sm, and each element is an equal amount of substance.

4. The method for preparing the oxide high entropy ceramic fibers according to claim 1, characterized in that four or more of four or more of the organic matter polymer precursors of Zr, Hf, Ti, Ce, Y, La, Gd, Er, Sm are used as the metal source.

5. The method for preparing the oxide high entropy ceramic fibers according to claim 1, characterized in that the mass ratio of the metal source, the spinning solvent, and the spinning aid is (15-20):(25-40):(0.075-0.1).

6. The method for preparing the oxide high entropy ceramic fibers according to claim 1, characterized in that the spinning liquid propulsion speed is 1.5-3.5 ml/h, and the humidity of the spinning environment is 10%-40%.

7. The method for preparing the oxide high entropy ceramic fibers according to claim 1, characterized in that the heat treatment temperature is 700° C-1100° C.

8. The method for preparing the oxide high entropy ceramic fiber according to claim 1, characterized in that the heat treatment process is as follows: the temperature increase rate is 0.5° C./min-1° C./min before 400° C., the temperature increase rate is 1° C./min-3° C./min after 400° C., the holding time is 1-2 h, and cooling with the furnace.

9. The method for preparing the oxide high-entropy ceramic fibers according to claim 1, characterized in that when the metal source contains hafnium-element organic polymer precursor, the organic polymer precursor is synthesized in the following steps:
(i) hafnium oxychloride octahydrate, acetylacetone, and triethylamine are used as the main raw materials, which are diluted in an alcoholic solvent, and the solution is mixed homogeneously by using magnetic stirring, and after stirring, it is dried under reduced pressure at 30° C. to 40° C. to obtain polyacetylacetone hafnium containing triethylamine hydrochloride; and
(ii) the polyacetylacetonate hafnium containing triethylamine hydrochloride is immersed in acetone, and filtered after standing for 24 to 72 hours to remove triethylamine hydrochloride, and the resulting filtrate is dried under reduced pressure at 20° C. to 30° C. to obtain polyacetylacetonate hafnium powder.

10. The method for preparing the oxide high-entropy ceramic fibers according to claim 9, characterized in that the molar ratio of hafnium oxychloride octahydrate: acetylacetone:
triethylamine in step (i) is: 1:0.5-2:1.5-3, and the amount of alcohol solvent added to each mole of hafnium oxychloride octahydrate is 900-1300 g.

11. The method for preparing the oxide high-entropy ceramic fibers according to claim 9, characterized in that the alcohol solvent in step (i) is anhydrous ethanol or anhydrous methanol.

12. The method for preparing the oxide high entropy ceramic fiber according to claim 9, characterized in that each gram of polyacetylacetonate hafnium is added with 10 ml to 30 ml of acetone in step (ii), the resting time is 24h to 72 h, and the drying temperature is 20° C. to 30° C.
